(19) United States
(12) Patent Application Publication
(10) Pub. No.: US 2025/0290207 A1
(43) Pub. Date: Sep. 18, 2025

(54) Photocatalytic Water Splitting with Separate H2 and O2 Production

(71) Applicant: The Regents of the University of Michigan, Ann Arbor, MI (US)

(72) Inventors: Zetian Mi, Ann Arbor, MI (US); Peng Zhou, Ann Arbor, MI (US)

(21) Appl. No.: 18/861,362

(22) PCT Filed: May 1, 2023
(86) PCT No.: PCT/US2023/020623

§ 371 Date: Oct. 29, 2024

Related U.S. Application Data
(60) Provisional application No. 63/336,952, filed on Apr. 29, 2022.

(51) Int. Cl. C25B 1/04; C25B 1/55; C25B 9/23; C25B 9/50; C25B 11/061; C25B 11/087

(52) U.S. Cl. CPC C25B 1/04; C25B 1/55; C25B 9/23; C25B 9/50; C25B 11/061; C25B 11/087

(57) ABSTRACT

A water splitting system includes a hydrogen production chamber including a hydrogen production port, an oxygen production chamber including an oxygen collection port, an ion exchange membrane coupling the hydrogen production chamber and the oxygen production chamber, and a photocatalytic structure including a first catalytic portion disposed in the hydrogen production chamber and a second catalytic portion disposed in the oxygen production chamber. The first catalytic portion is configured for production of hydrogen via the hydrogen production port. The second catalytic portion is configured for production of oxygen via the oxygen production port.

### CROSS-REFERENCE TO RELATED APPLICATION

This application claims the benefit of U.S. provisional application entitled “Photocatalytic Water Splitting with Separate H₂ and O₂ Production,” filed Apr. 29, 2022, and assigned Ser. No. 63/336,952, the entire disclosure of which is hereby expressly incorporated by reference.

### STATEMENT REGARDING FEDERALLY SPONSORED RESEARCH OR DEVELOPMENT

This invention was made with government support under Contract No. W56HZV-21-C-0076 awarded by the U.S. Army. The government has certain rights in the invention.

### BACKGROUND OF THE DISCLOSURE

### Field of the Disclosure

The disclosure relates generally to photocatalytic water splitting.

### Brief Description of Related Technology

Solar hydrogen production from water and sunlight is a promising and economical strategy for renewable energy storage and conversion. To date, studies on high-purity solar hydrogen production have been largely focused on the high-cost and complex photovoltaic electrolytic (PV-E) and photoelectrochemical (PEC) pathways.

Photocatalytic solar water splitting for green hydrogen production has been considered as a cost effective approach relative to the extensively studied PV-E and PEC water splitting. The photocatalytic water splitting is free of electrical wires, and bias, thereby avoiding any significant ohmic loss that often limits the performance of PV-E and PEC water splitting systems. Significantly, conventional PEC water splitting is often conducted in an electrolytic tank and involves the use of a highly conductive electrolyte, e.g., sulfuric acid, which severely limits its practical application. In contrast, photocatalytic water splitting can utilize pure water, sea water, or tap water, which significantly reduces the system cost and mitigates photocatalyst corrosion, stability, and safety related issues, and therefore is much more suited for practical application. For instance, the commonly reported high efficiency PEC water splitting devices exhibit very poor stability, often limited to a few hours of stable operation under practical two-electrode configuration. Photocatalytic water splitting, with its long-term stability and simplicity, is projected to have very low levelized cost of hydrogen generation.

A major challenge for photocatalytic water splitting, however, is the co-generation of H₂/O₂ gas mixtures in the same reaction chamber. The obtained hydrogen is unavoidably mixed with oxygen in the overall water splitting, which undesirably increases the cost of hydrogen/oxygen separation. Moreover, the mixed hydrogen and oxygen also leads to safety problems.

### SUMMARY OF THE DISCLOSURE

In accordance with one aspect of the disclosure, a water splitting system includes a hydrogen production chamber including a hydrogen production port, an oxygen production chamber including an oxygen collection port, an ion exchange membrane coupling the hydrogen production chamber and the oxygen production chamber, and a photocatalytic structure. The photocatalytic structure includes a first catalytic portion disposed in the hydrogen production chamber, and a second catalytic portion disposed in the oxygen production chamber. The first catalytic portion is configured for production of hydrogen via the hydrogen production port. The second catalytic portion is configured for production of oxygen via the oxygen production port.

In accordance with another aspect of the disclosure, a method for water splitting includes immersing one of an oxygen evolution reaction (OER) photocatalytic structure and a hydrogen evolution reaction (HER) photocatalytic structure in water contained by a chamber, and in which a species of a redox pair is present, exposing the chamber to light for illumination of the OER photocatalytic structure or the HER photocatalytic structure, the illumination converting the species of the redox pair, collecting one of oxygen and hydrogen produced by the illumination, regenerating the species of the redox pair in the water, and collecting the other of oxygen and hydrogen produced while the species of the redox pair species is regenerated.

In accordance with yet another aspect of the disclosure, a water splitting system includes a hydrogen production chamber including a hydrogen production port, an oxygen production chamber including an oxygen collection port, a liquid flow path coupling the hydrogen production chamber and the oxygen production chamber for exchange of a redox pair, a hydrogen evolution reaction (HER) photocatalytic structure disposed in the hydrogen production chamber, and an oxygen evolution reaction (OER) photocatalytic structure disposed in the oxygen production chamber.

In connection with any one of the aforementioned aspects, the systems, devices and/or methods described herein may alternatively or additionally include or involve any combination of one or more of the following aspects or features. The first catalytic portion includes a first side of the photocatalytic structure. The second catalytic portion includes a second side of the photocatalytic structure. The water splitting system further includes a separator disposed between the hydrogen production chamber and the oxygen production chamber. The photocatalytic structure is disposed along, integrated with, the separator. The photocatalytic structure includes a plurality of nanowires extending into the hydrogen production chamber. The first catalytic portion includes a plurality of nanowires extending outward from a substrate of the photocatalytic structure, and a distribution of catalyst nanoparticles across the plurality of nanowires. Each nanowire of the plurality of nanowires is configured for photogeneration of charge carriers. The second portion includes a catalyst layer supported by a substrate of the photocatalytic structure. The second portion further includes a metal layer disposed between the catalyst layer and the substrate. The second portion includes a distribution of catalyst nanoparticles supported by a metal substrate of the photocatalytic structure. Regenerating the species of the redox pair includes switching which one of the OER photocatalytic structure and the HER photocatalytic structure is immersed in the water in the chamber, and illuminating the OER photocatalytic structure or the HER photocatalytic structure immersed in the water after switching the OER photocatalytic structure and the HER photocatalytic structure. The method further includes switching the OER photocatalytic structure and the HER photocatalytic structure again after the species of the redox pair is regenerated, and repeating exposure of the chamber, collection of oxygen or hydrogen, and regeneration of the species of the redox pair. Regenerating the species of the redox pair includes applying a voltage to the water via a pair of electrodes immersed in the water. Applying the voltage is configured for an electroreduction of the other species of the redox pair in the water. The method further includes ceasing to apply the voltage to the water after the species of the redox pair is regenerated, and repeating exposure of the chamber, collection of oxygen or hydrogen, and regeneration of the species of the redox pair. The liquid flow path includes a channel between the hydrogen production chamber and the oxygen production chamber. The water splitting system further includes a separator disposed along the hydrogen production chamber and the oxygen production chamber, such that the liquid flow path includes an opening in the separator. The OER photocatalytic structure includes a first substrate, a first plurality of nanowires extending outward from the substrate, and a first distribution of catalyst nanoparticles across the plurality of nanowires, and the HER photocatalytic structure includes a second substrate, a second plurality of nanowires extending outward from the substrate, and a second distribution of catalyst nanoparticles across the plurality of nanowires. Each nanowire of the first and second pluralities of nanowires is configured for photogeneration of charge carriers.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a schematic view of a water splitting system with separate hydrogen and oxygen production in accordance with one example.

FIG. 2 is a schematic view of a water splitting system with photocatalytic structure (e.g., wafer) exchanges and a redox shuttle for separate hydrogen and oxygen production in accordance with one example.

FIG. 3 depicts schematic and photographic views of a water splitting system with multiple chambers for separate hydrogen and oxygen production in accordance with one example.

FIG. 4 depicts a scanning electron microscopy (SEM) image of a plurality of InGaN nanowires for photocatalytic water splitting with H₂/O₂ separation in accordance with one example, along with graphical plots of the photoluminescence spectrum, band-edge potentials, and hydrogen-production rate of the InGaN nanowires.

FIG. 5 is a schematic view of a water splitting system with an integrated photocatalytic structure (e.g., wafer) for separate hydrogen and oxygen production in accordance with one example.

FIG. 6 depicts a schematic view of a water splitting system with an integrated photocatalytic structure (e.g., wafer) for separate hydrogen and oxygen production in accordance with another example, along with an SEM image of a plurality of GaN nanowires on a Ni substrate for photocatalytic water splitting and a graphical plot of hydrogen production rates with a Pt/GaN-Ni/Ir device.

FIGS. 7A, 7B, 7C, and 7D are schematic views of water splitting systems with a redox shuttle for separate hydrogen and oxygen production in accordance with several examples.

FIG. 8 are graphical plots of (a) selective hydrogen production via a photocatalytic wafer having a Rh/Cr₂O₃-InGaN catalyst arrangement in 0.1 M KI solution, and (b) selective oxygen production via a photocatalytic wafer having a CoOₓ/InGaN catalyst arrangement in 0.1 M KIO₃ solution.

FIG. 9 is a schematic view of a water splitting system with interconnected chambers for exchange of a redox shuttle and separate hydrogen and oxygen production in accordance with one example.

FIG. 10 is a schematic view of a water splitting system with interconnected chambers for exchange of a redox shuttle and separate hydrogen and oxygen production in accordance with another example.

The embodiments of the disclosed systems, devices, and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Systems and methods for photocatalytic water splitting with separate hydrogen and oxygen are described. In some cases, the disclosed systems and devices include a photocatalytic structure integrated into a multiple chamber arrangement. The photocatalytic structure may include a photocatalytic wafer or other device. In other cases, multiple chambers are used to separately and simultaneously produce hydrogen and oxygen via exchange and/or regeneration of the species of a redox pair or shuttle. In still other cases, separate production of hydrogen and oxygen is achieved via a redox pair in a single chamber through photo-and/or electro-reduction-based regeneration.

The disclosed methods and systems may produce the hydrogen and oxygen simultaneously or sequentially. In simultaneous cases, discrete ports for respective chambers may be used to collect the hydrogen and oxygen separately. In sequential cases, one or both of the hydrogen and oxygen production may be implemented during illumination (e.g., sunlight exposure) of the photocatalytic wafer(s). In some cases, the hydrogen and oxygen production may be implemented over a daily cycle involving illumination (e.g., daylight hours) and non-illumination (e.g., nighttime hours). For instance, a bias voltage may be applied for electro-reduction for, e.g., oxygen evolution during each night.

The disclosed methods and systems provide photocatalytic solar water splitting for scalable, cost effective production of green hydrogen. The disclosed methods and systems address the challenge of co-generation of H₂/O₂ gas mixtures, including, in some cases, involving the same reaction chamber. The disclosed methods and systems utilize one of two strategies to overcome the challenges of photocatalytic water splitting. In the first approach, the photocatalyst wafer is integrated with a suitable proton exchange membrane and is positioned between two compartments of the reaction chamber. In some examples, photo-generated charge carriers are spatially separated to the front and backside of the photocatalyst wafer, thereby leading to the separate generation of H₂ and O₂ at the device level. In the second approach, the overall water splitting reaction is separated into two half reactions, including the cathodic half reaction for H₂ generation and the anodic reaction for O₂ generation. The two reactions are implemented in either separate locations or different times, mediated by redox shuttles, thereby leading to the spatial separation of H₂ and O₂ at the device level. In some cases, a photocatalytic water splitting reactor or system includes two interconnected compartments for separate H₂ and O₂ generation mediated by suitable redox shuttles. In other cases, a photocatalytic water splitting reactor includes a single compartment for generating H₂ and O₂ in sequence (different times) for effective H₂ and O₂ separation. In each approach, the redox reactions (hydrogen evolution and oxygen evolution) can be separately driven by light, electricity, or a combination light and electricity, thereby offering flexibility in the system design, integration, and operation.

The disclosed methods and systems avoid the use of, or reliance on, a downstream H₂/O₂ separator. Such downstream separators significantly increase the overall system cost and footprint, thereby reducing the overall solar-to-hydrogen conversion efficiency, and further presenting restrictions on the gas flow rate, pressure, and reaction chamber design. Furthermore, such H₂/O₂ separators have failed to provide solutions with relatively low cost, low power consumption, and ultrahigh purity H₂ separation.

Although described in connection with nanowire-based photocatalytic arrangements, the disclosed methods and systems may use a wide variety of nanostructures and/or other catalytic arrangements. For instance, the photocatalytic wafers may include various types and shapes of scaffolding or frameworks for supporting a distribution of catalytic nanoparticles and/or other catalysts.

The disclosed methods and systems may alternatively or additionally use still other photocatalyst structures or arrangements. For instance, the disclosed systems and methods are thus not limited to wafer-based photocatalytic structures or devices. In some cases, the disclosed methods and systems may alternatively or additionally include or use suspended photocatalyst particles or other structures.

Although described in connection with InGaN-based and GaN-based nanostructures for photogeneration of charge carriers, the disclosed methods and systems may use a wide variety of semiconductor materials. The disclosed methods and systems are thus not limited to use of III-nitride semiconductors, semiconductor alloys, or semiconductors. For instance, various oxides (e.g., TiO₂, SrTiO₃), oxynitrides, and other photocatalyst materials may be used. The composition and other characteristics of the nanoparticles distributed across the nanowires may also vary from the examples described herein. For instance, the nanoparticles may be composed of, or otherwise include, Pt and Pd for hydrogen production and NiOₓ and IrO₂ for oxygen production. The composition and other characteristics of the substrate of the devices may also vary from the examples described herein. For instance, the substrate may be composed of, or otherwise include, sapphire, Mo, Ti, etc.

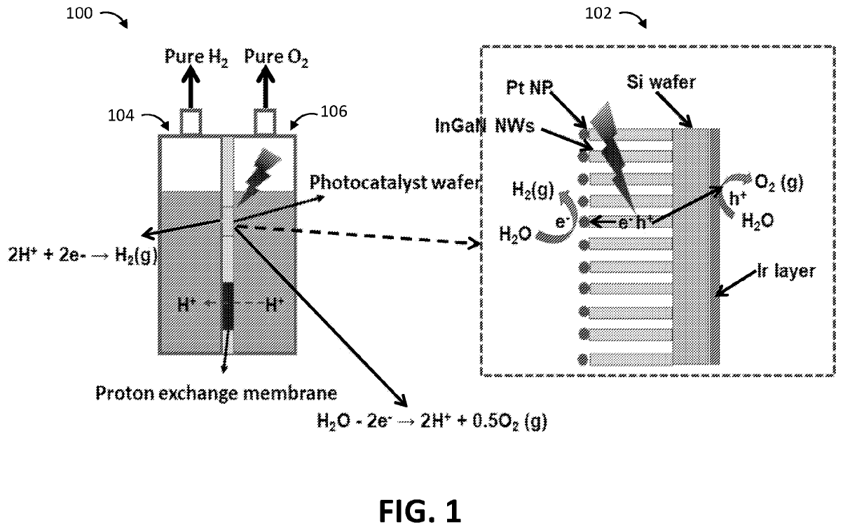

FIG. 1 shows an example of a water splitting system 100 in which a photocatalyst wafer 102 is integrated with two chambers 104, 106, one for hydrogen production and the other for oxygen production. In this example, the photocatalytic wafer 102 is integrated with a suitable proton exchange membrane and is positioned between two chambers 104, 106 (or two compartments of a reaction chamber). Photo-generated charge carriers are spatially separated. For instance, in the example shown, electrons migrate to the nanowire surfaces, whereas holes migrate toward the backside of the substrate. With the deposition of suitable co-catalysts, hydrogen evolution reaction occurs in the chamber 104 (or compartment), whereas oxygen evolution reaction occurs in the chamber 106 (or compartment), thereby leading to the separate generation of H₂ and O₂ at the device level.

The water splitting system 100 further includes a ion (or proton) exchange membrane coupling the hydrogen production chamber and the oxygen production chamber. For example, a Nafion membrane may be used. In the example of FIG. 1, the membrane is disposed along the wall or other separator between the hydrogen production chamber 104 and the oxygen production chamber 106.

The disposition of the wafer in the water splitting system 100 provides for the spatial separation of the photo-generated electrons and holes. The example of FIG. 1 provides a fully integrated solar hydrogen device having efficient charge carrier separation and extraction. Other techniques to address the challenge of charge carrier separation and extraction are described below.

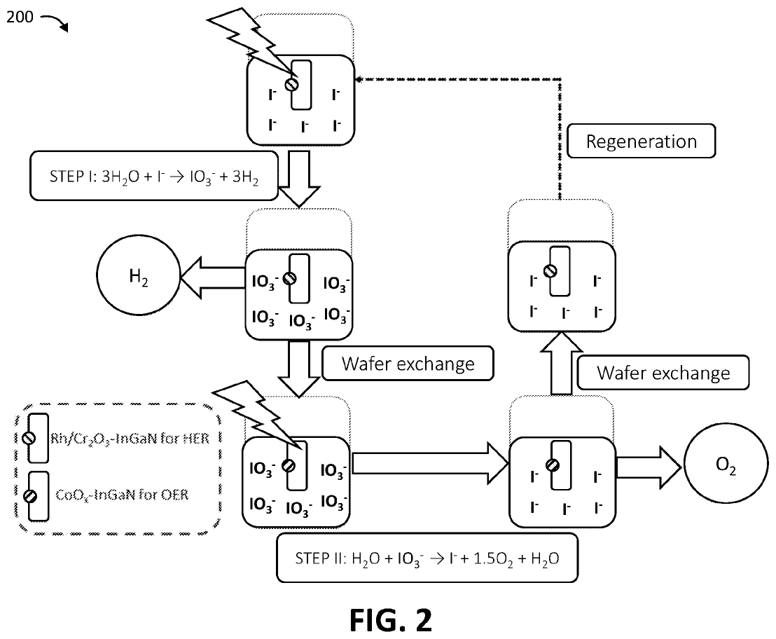

FIG. 2 shows an example of a water splitting system 200 and method in which the water splitting reaction is separated into two half reactions, including the cathodic half reaction for H₂ generation and the anodic reaction for O₂ generation. In this example, the two reactions take place sequentially, i.e., at different times, mediated by redox shuttles, thereby leading to the spatial separation of H₂ and O₂ at the device level. Alternatively or additionally, the two reactions occur in separate locations (e.g., separate chambers).

The approach shown in FIG. 2 offers flexibility in the design of the reaction chamber for overall water splitting and separate H₂/O₂ production. For example, an iodate/iodide (IO₃⁻/I⁻) redox pair can be adopted to produce high-purity hydrogen and oxygen at different times or different locations. The system 200 may operate at near-neutral pH conditions with the use of proton-coupled electron transfer redox shuttles. Utilizing this approach, solar-to-hydrogen efficiency of about 2.5% were achieved, which is the highest value reported for solar water splitting with the capability of simultaneous H₂/O₂ separation.

Further examples of the system design approaches shown in FIGS. 1 and 2 are described below. The examples provide alternative parameters, transport and kinetic processes for efficient solar-to-hydrogen conversion. In some of the examples, a photocatalytic water splitting reactor or system includes two interconnected compartments or chambers for separate H₂ and O₂ generation mediated by suitable redox shuttles. In other examples, a photocatalytic water splitting reactor or system includes a single compartment for generating H₂ and O₂ in sequence (different times) for effective H₂ and O₂ separation. In each approach, the redox reactions (hydrogen evolution and oxygen evolution) can be separately driven by light, electricity, or any combination of light and electricity, thereby offering tremendous flexibility in the system design, integration, and operation. Moreover, the two compartments or chambers may be further integrated in a tandem configuration for optimum sunlight absorption and utilization.

In each of the examples, the systems and methods include or use wafer scale InGaN nanowire photocatalyst arrangements on silicon or other substrates. Further details regarding the nanostructure-based photocatalyst arrangements are set forth in International Application No. PCT/US2021/056804 (“Water Splitting Device Protection”), and U.S. Pat. No. 9,112,085 (“High Efficiency Broadband Semiconductor Nanowire Devices”), the entire disclosures of which are hereby incorporated by reference. Other nanostructure shapes and arrangements may be used. The disclosed systems and methods may alternatively or additionally use or include still other photocatalyst structures, including, for instance, planar structures.

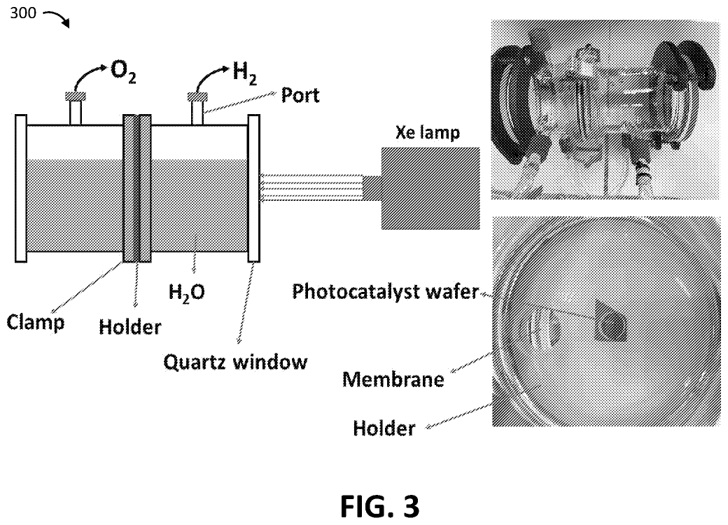

FIG. 3 shows an example of a water splitting system 300 in which two chambers are connected with a quartz holder. Two holes in quartz holder are used to install photocatalyst wafer and membrane, respectively.

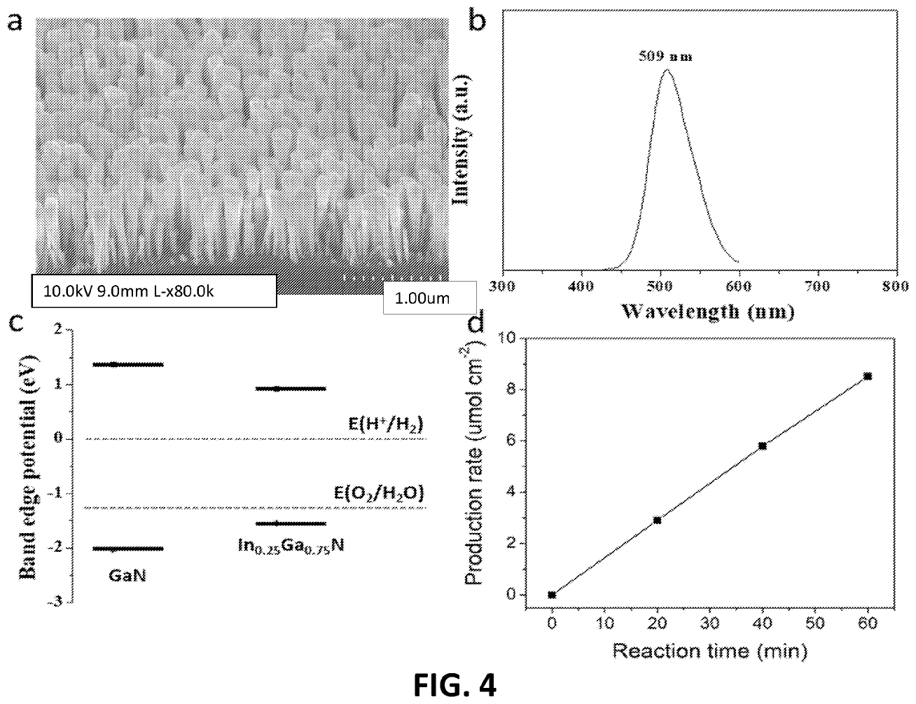

The photocatalyst wafers are prepared by growing p-type InGaN nanowires on p-type silicon wafer, as shown in part (a) of FIG. 4. The InGaN nanowires have a band gap of 2.45 eV and suitable band-edge potential for the water redox reaction, as shown in parts (b) and (c) of FIG. 4. In this example, platinum (Pt) nanoparticles for producing hydrogen are deposited on the surface of the InGaN nanowires, while Ni, Au and Ir layers for capturing holes and producing oxygen are deposited on the back side of silicon wafer in sequence.

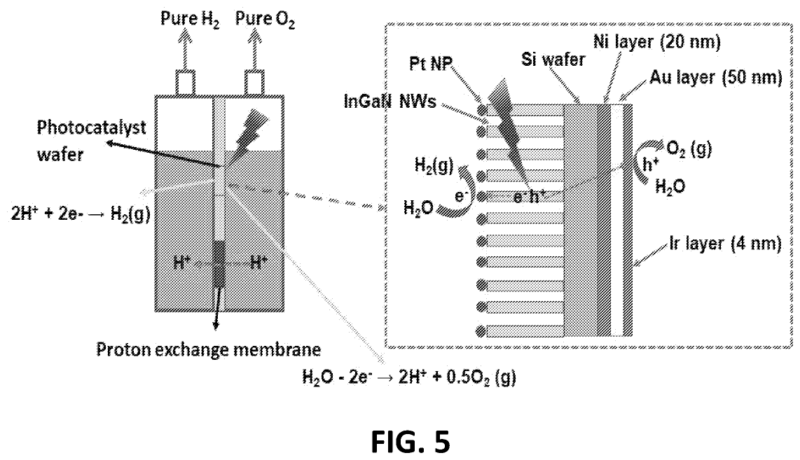

As shown in the schematic view of FIG. 5, with photoexcitation, the InGaN nanowires produce photogenerated electrons and holes. The photogenerated electrons are transferred to the Pt nanoparticles for hydrogen production, while the photogenerated holes move to the Ir layer for oxygen production. As a result, hydrogen with a formation rate of 8.5 μmol cm⁻² h⁻¹ was selectively produced in the left chamber (see part (d) of FIG. 4), thereby enabling the separation of H₂ and O₂ at the device (e.g., wafer) level.

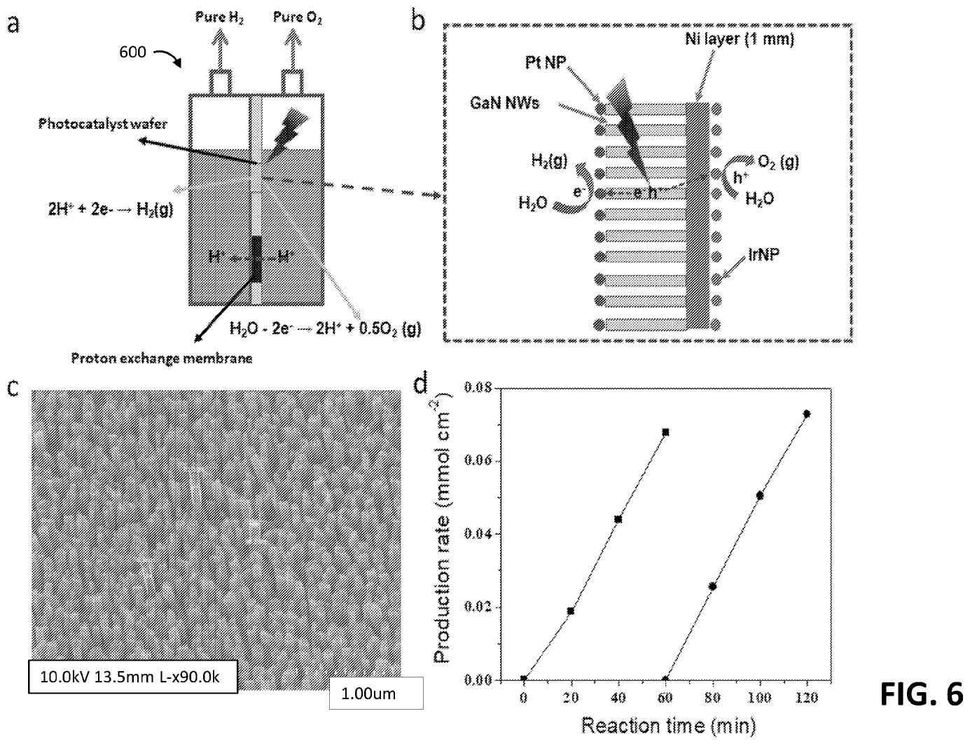

FIG. 6 shows an example of a water splitting system 600 with a photocatalytic wafer configured to accelerate the charge transfer between GaN nanowires and an Ir layer. In this example, a metallic Ni wafer directly replaced the semiconductor silicon as the substrate of GaN. The Ni wafer forms a good ohmic contact with the p-doped Ga(In)N nanowire photocatalyst light absorbers, thereby enabling more efficient collection of photo-generated holes. Also, in this example, Ir nanoparticles are used as the cocatalyst for oxygen production. The Ir nanoparticles present a larger specific surface area than the Ir layer. Similarly, GaN nanowires are well grown on Ni wafer, as shown in part (c) of FIG. 6. In operation, hydrogen and oxygen are produced on the GaN-supported Pt nanoparticles and Ni-supported Ir nanoparticles, respectively. As a result, hydrogen was selectively produced in the left chamber at a higher rate of 0.07 mmol cm⁻² h⁻¹, as shown in part (d) of FIG. 6.

In the above-described examples, the charge transfer rate between the two sides of the photocatalyst wafer may limit the further improvement on the efficiency of the hydrogen production in the photocatalytic water splitting.

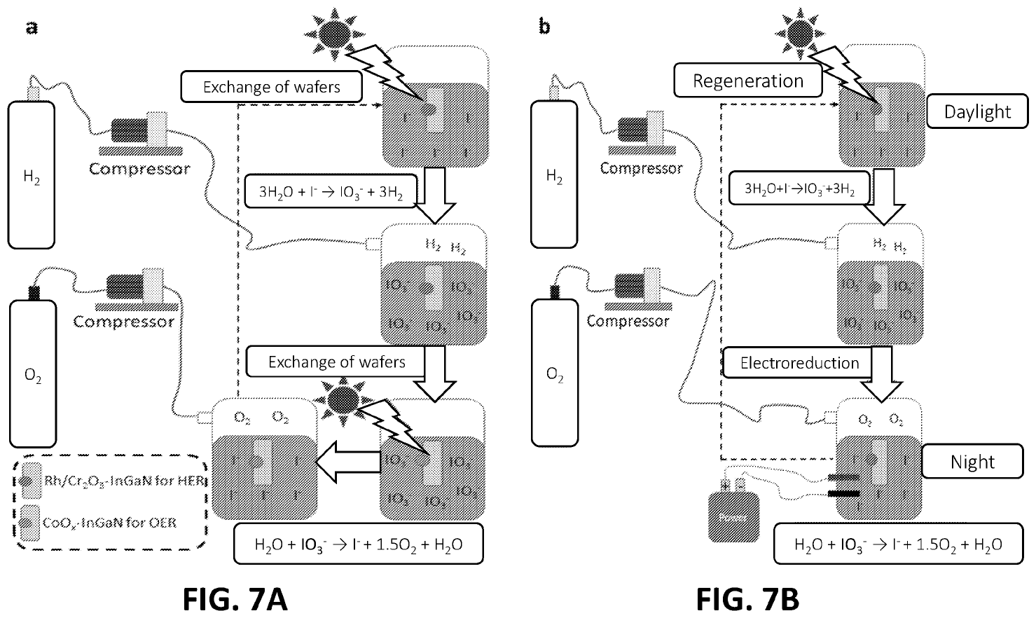

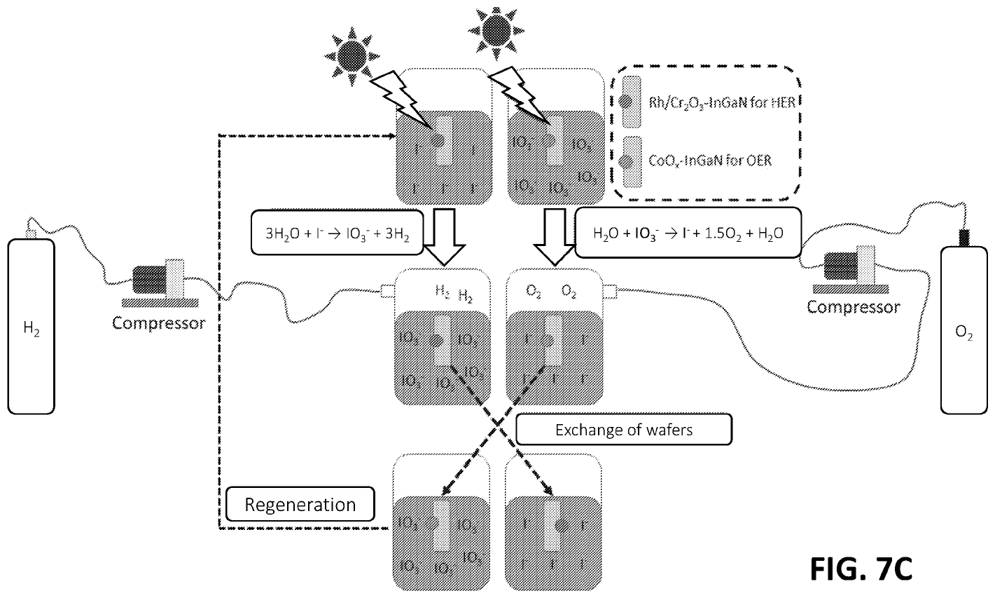

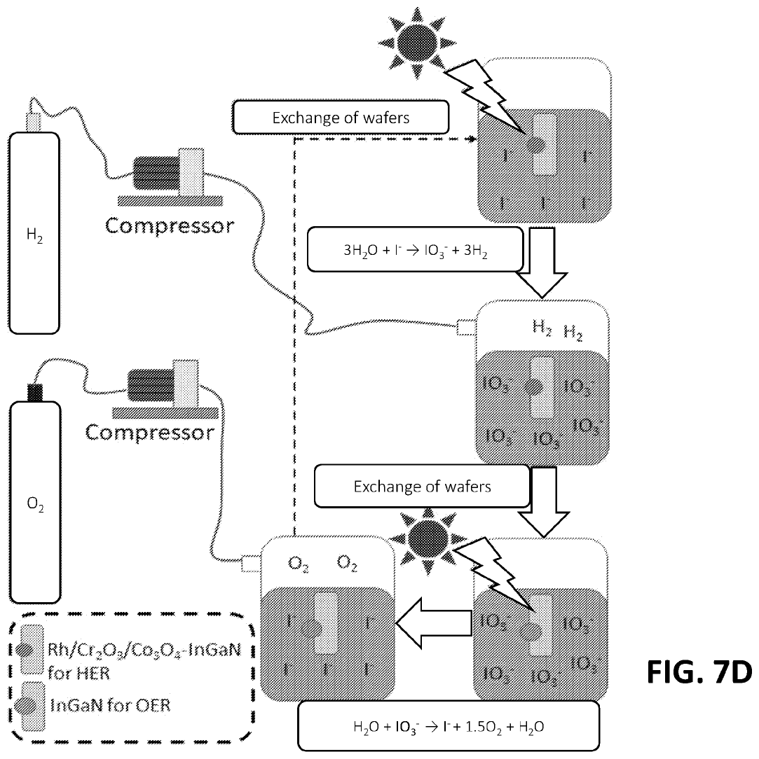

To improve efficiency, a number of examples based on a redox pair provide an economical and high-efficiency H₂/O₂ source separation approach. In this approach, an iodate/iodide (IO₃⁻/I⁻) redox pair was adopted to produce the separated high-purity hydrogen and oxygen in different time or space. The separation of H₂/O₂ at the device level may thus be achieved. FIGS. 7A-7D provide several examples of methods and systems that implement this approach.

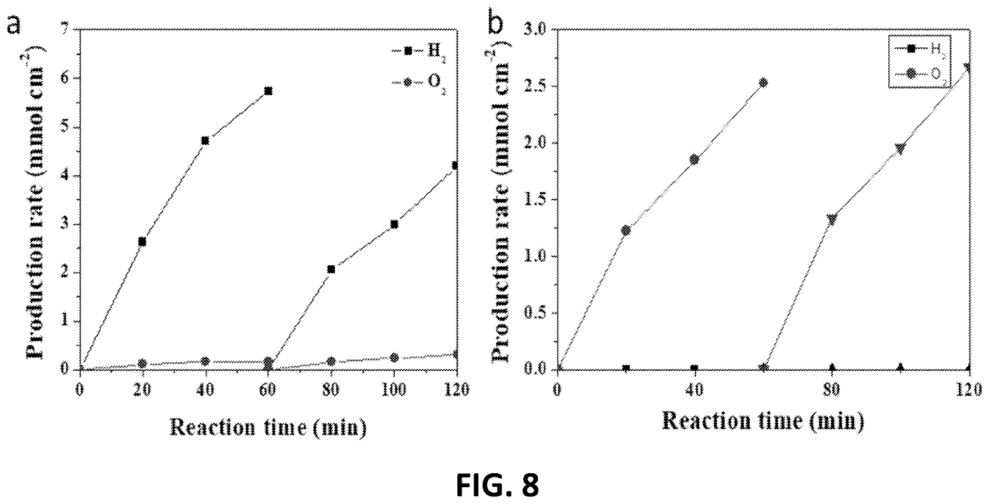

In the example system and method shown in FIG. 7A, a chamber having iodide (I⁻) and a wafer with a Rh/Cr₂O₃-InGaN catalyst arrangement (e.g., Rh/Cr₂O₃ nanoparticles on InGaN nanowires) to produce hydrogen and iodate (IO₃⁻) under sunlight. The produced hydrogen is stored in a hydrogen tank via a compressor. Then, the wafer with the Rh/Cr₂O₃-InGaN catalyst arrangement is replaced by a wafer with a CoOₓ-InGaN catalyst arrangement (e.g., CoOₓ nanoparticles on InGaN nanowires). The CoOₓ-InGaN wafer converts the produced IO₃⁻ in the previous step into I⁻ again. Meanwhile, oxygen is also produced and stored in an oxygen tank. The system is then returned to its initial state by replacing the CoOₓ-InGaN wafer with the Rh/Cr₂O₃-InGaN wafer. Thus, this procedure may be repeated to produce hydrogen and oxygen in different times and, in so doing, providing hydrogen and oxygen separation. In this approach, a high production rate of 4.95 mmol h⁻¹ cm⁻² was experimentally achieved on hydrogen production, which corresponds to a maximum STH of 4.5%, as shown in FIG. 8.

With reference to FIG. 7B, another example water splitting system and method are configured to increase or maximize the utilization efficiency of sunlight in during daylight hours via electroreduction-assisted photocatalytic water splitting. In this case, the chamber containing I⁻ and the Rh/Cr₂O₃-InGaN catalyst arrangement produces hydrogen and IO₃⁻ in daylight. After the hydrogen is stored, the produced IO₃⁻ is directly electro-reduced into I⁻ again, e.g., at night. To that end, a bias voltage is applied via a pair of electrodes. Meanwhile, oxygen is produced separately. As a result, the system is regenerated via the electroreduction. Hence, the procedure may then be repeated to produce the separated hydrogen and oxygen. The method also decreases the complexity of system operation and design.

The electroreduction may be implemented to any desired extent in connection with one or more of the other examples described herein.

Alternatively or additionally, a bias voltage is applied during hydrogen production. The bias voltage may be applied with or without concurrent photocatalysis.

FIG. 7C shows another example water splitting system and method involving exchanging photocatalytic wafers or other devices. In this case, two separated chambers are used in the reaction system. The I⁻ and Rh/Cr₂O₃-InGaN are disposed in the left chamber, while IO₃⁻ and CoOₓ-InGaN are disposed in the right chamber. In the first portion or stage of the procedure, the hydrogen and oxygen are produced in the left and right chambers, respectively. Meanwhile, I-in the left chamber and IO₃⁻ in the right chamber are converted into IO₃⁻ and I⁻, respectively. After the first stage, the photocatalyst wafers in the two chambers are exchanged with one another. As a result, the reaction system is regenerated. Thus, the procedure can be repeated to continuously produce high-purity hydrogen with source separation capability.

FIG. 7D shows yet another example water splitting system and method involving exchanging photocatalytic wafers or other devices. Economical and high-efficient source separation was again achieved based on a redox pair. In this case, an iodate/iodide (IO₃⁻/I−) redox pair is used to produce the separated high-purity hydrogen and oxygen in different time or space. As shown in FIG. 7D, the hydrogen is first produced by oxidizing I⁻ into IO₃⁻ on a Rh/Cr₂O₃/CoOₓ-InGaN wafer in a first step. In a second step, unloaded InGaN nanowires on another wafer are used to convert IO₃⁻ into I⁻. Meanwhile, the oxygen is produced, and the solution is regenerated. As a result, hydrogen and oxygen were produced at different times, which achieved the H₂/O₂ source separation. Firstly, the two half reactions using I⁻ and IO₃⁻ as electron donor and acceptor were demonstrated to selectively produce hydrogen and oxygen on the corresponding photocatalysts, respectively, which verifies the feasibility of using I⁻ and IO₃⁻ as a redox pair in the photocatalytic water splitting with hydrogen/oxygen source separation.

In one example, the photocatalytic water splitting with hydrogen/oxygen source separation was performed on Rh/Cr₂O₃/CoOₓ-InGaN and pristine InGaN in 0.050 M KI and 0.050 M KIO₃. Each cycle included one-hour HER and two-hour OER, which contributed to the production of stoichiometric H₂ and O₂ with a ratio of 2:1. The hydrogen purity in HER reached above 95%. Meanwhile, the STH efficiency reached over 2.5% for H₂ production in four stable cycles. STH and hydrogen purity showed an observable dependence on the concentration of the redox pair. When the concentration of the redox pair was increased to 0.05 M, the hydrogen purity was higher than 95% and the STH only showed a slight decrease.

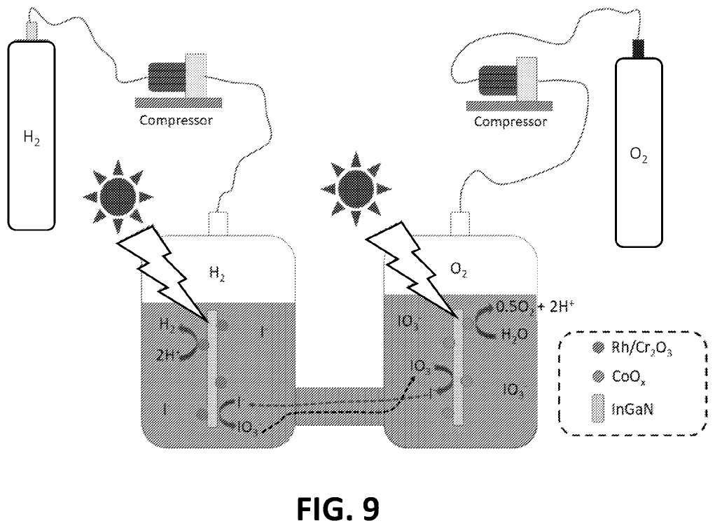

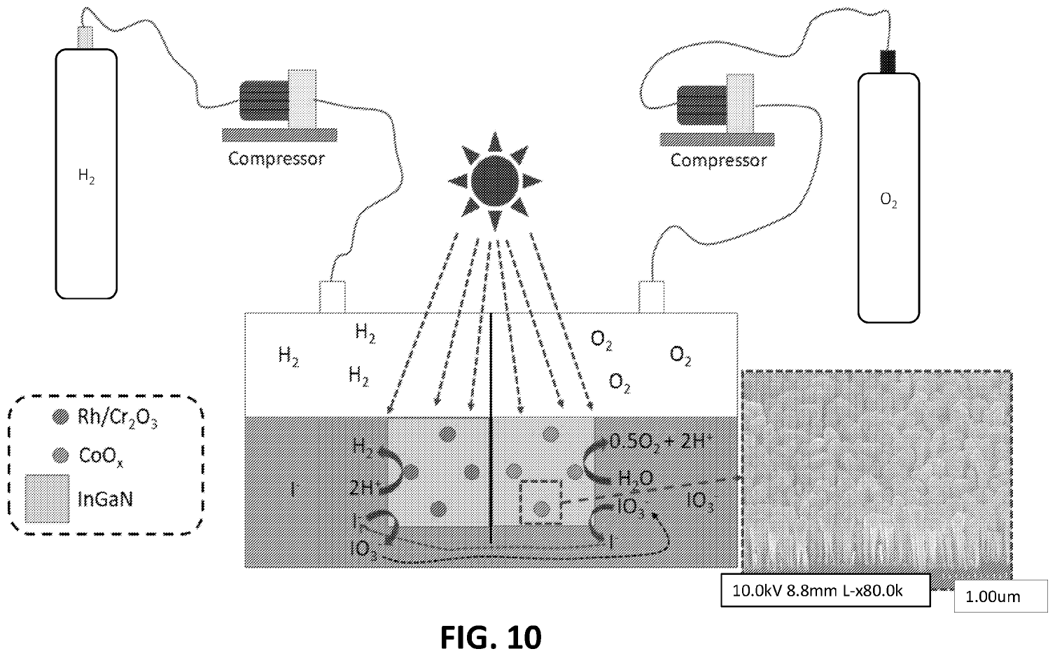

FIGS. 9 and 10 show further examples of redox shuttle-based water splitting systems and methods. In these cases, the separate production of hydrogen and oxygen may be achieved without the assistance of electroreduction.

In FIG. 9, two chambers are coupled to one another via a channel. The coupling facilitates the exchange of the redox pair, e.g., IO₃⁻/I⁻. In this example, the two photocatalyst wafers are installed in the different chambers without exchanges during operation. The species of the redox pair produced during operation are spontaneously diffused into the corresponding regions for production of hydrogen and oxygen through the channel between the two chambers, respectively. Separation of the hydrogen and oxygen produced in the photocatalytic water splitting is still achieved despite the coupling, as the gases float upward toward the outlet ports.

As shown in FIG. 9, the system may use two light sources. One light source illuminates the hydrogen production chamber. The other light source illuminates the oxygen production chamber. In other cases, a single light source may be used.

FIG. 10 shows an example in which a single light source, e.g., natural sunlight, is used to illuminate both chambers. To that end, two photocatalyst wafers may be disposed in close proximity. In this example, the wafers are disposed in parallel and/or otherwise aligned with one another in the two chambers. The two photocatalyst wafers are spatially separated by a separator, e.g., a quartz clapboard. In this case, the natural sunlight simultaneously irradiates the two photocatalyst wafers, which is useful in connection with concentrated sunlight. As in the above-described example, the chambers are coupled to one another (e.g., at the bottom of the chambers) to permit the transfer and exchange of the species (e.g., IO₃⁻/I⁻) of the redox pair, which enables the continuous hydrogen and oxygen production in the photocatalyst wafer splitting. In this example, the coupling is provided via an opening in the separator. Again, hydrogen is selectively and separately produced in the chamber with the Rh/Cr₂O₃-InGaN photocatalyst wafer despite the presence of the opening.

One or both of the redox reactions (hydrogen evolution and oxygen evolution) in the above-described examples may be driven by light, electricity, or any combination of light and electricity. The disclosed methods and systems thus provide flexibility in design, integration, and operation.

Although described in connection with a redox shuttle involving the iodide/iodate (IO₃⁻/I⁻) redox pair, additional or alternative redox pairs may be used. For instance, the disclosed methods and systems may use or include bromine/bromide and Fe³⁺/Fe²⁺.

Described above are systems and methods that overcome the challenges of photocatalytic water splitting to produce high-purity solar hydrogen from water and sunlight. The above-described examples establish experimental demonstration of a fully integrated photocatalytic solar water splitting system with separate H₂ and O₂ generation. For instance, with the use of InGaN photocatalyst nanostructures, the disclosed methods and systems achieved a solar-to-hydrogen efficiency of about 5%.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A water splitting system comprising:
a hydrogen production chamber comprising a hydrogen production port;
an oxygen production chamber comprising an oxygen collection port;
an ion exchange membrane coupling the hydrogen production chamber and the oxygen production chamber; and
a photocatalytic structure comprising:
a first catalytic portion disposed in the hydrogen production chamber; and
a second catalytic portion disposed in the oxygen production chamber;
wherein:
the first catalytic portion is configured for production of hydrogen via the hydrogen production port; and
the second catalytic portion is configured for production of oxygen via the oxygen production port.

2. The water splitting system of claim 1, wherein:
the first catalytic portion comprises a first side of the photocatalytic structure; and
the second catalytic portion comprises a second side of the photocatalytic structure.

3. The water splitting system of claim 1, further comprising a separator disposed between the hydrogen production chamber and the oxygen production chamber, wherein the photocatalytic structure is disposed along, integrated with, the separator.

4. The water splitting system of claim 1, wherein the photocatalytic structure comprises a plurality of nanowires extending into the hydrogen production chamber.

5. The water splitting system of claim 1, wherein the first catalytic portion comprises:
a plurality of nanowires extending outward from a substrate of the photocatalytic structure; and
a distribution of catalyst nanoparticles across the plurality of nanowires.

6. The water splitting system of claim 5, wherein each nanowire of the plurality of nanowires is configured for photogeneration of charge carriers.

7. The water splitting system of claim 1, wherein the second portion comprises a catalyst layer supported by a substrate of the photocatalytic structure.

8. The water splitting system of claim 7, wherein the second portion further comprises a metal layer disposed between the catalyst layer and the substrate.

9. The water splitting system of claim 1, wherein the second portion comprises a distribution of catalyst nanoparticles supported by a metal substrate of the photocatalytic structure.

10. A method for water splitting, the method comprising:
immersing one of an oxygen evolution reaction (OER) photocatalytic structure and a hydrogen evolution reaction (HER) photocatalytic structure in water contained by a chamber, and in which a species of a redox pair is present;
exposing the chamber to light for illumination of the OER photocatalytic structure or the HER photocatalytic structure, the illumination converting the species of the redox pair;
collecting one of oxygen and hydrogen produced by the illumination;
regenerating the species of the redox pair in the water; and
collecting the other of oxygen and hydrogen produced while the species of the redox pair species is regenerated.

11. The method of claim 10, wherein regenerating the species of the redox pair comprises:
switching which one of the OER photocatalytic structure and the HER photocatalytic structure is immersed in the water in the chamber; and
illuminating the OER photocatalytic structure or the HER photocatalytic structure immersed in the water after switching the OER photocatalytic structure and the HER photocatalytic structure.

12. The method of claim 11, further comprising:
switching the OER photocatalytic structure and the HER photocatalytic structure again after the species of the redox pair is regenerated; and
repeating exposure of the chamber, collection of oxygen or hydrogen, and regeneration of the species of the redox pair.

13. The method of claim 10, wherein regenerating the species of the redox pair comprises applying a voltage to the water via a pair of electrodes immersed in the water.

14. The method of claim 13, wherein applying the voltage is configured for an electroreduction of the other species of the redox pair in the water.

15. The method of claim 13, further comprising:
ceasing to apply the voltage to the water after the species of the redox pair is regenerated; and
repeating exposure of the chamber, collection of oxygen or hydrogen, and regeneration of the species of the redox pair.

16. A water splitting system comprising:
a hydrogen production chamber comprising a hydrogen production port;
an oxygen production chamber comprising an oxygen collection port;
a liquid flow path coupling the hydrogen production chamber and the oxygen production chamber for exchange of a redox pair;
a hydrogen evolution reaction (HER) photocatalytic structure disposed in the hydrogen production chamber; and
an oxygen evolution reaction (OER) photocatalytic structure disposed in the oxygen production chamber.

17. The water splitting system of claim 16, wherein the liquid flow path includes a channel between the hydrogen production chamber and the oxygen production chamber.

18. The water splitting system of claim 16, further comprising a separator disposed along the hydrogen production chamber and the oxygen production chamber, such that the liquid flow path comprises an opening in the separator.

19. The water splitting system of claim 16, wherein:
the OER photocatalytic structure comprises a first substrate, a first plurality of nanowires extending outward from the substrate, and a first distribution of catalyst nanoparticles across the plurality of nanowires; and
the HER photocatalytic structure comprises a second substrate, a second plurality of nanowires extending outward from the substrate, and a second distribution of catalyst nanoparticles across the plurality of nanowires.

20. The water splitting system of claim 16, wherein each nanowire of the first and second pluralities of nanowires is configured for photogeneration of charge carriers.
